(19) United States
(12) Patent Application Publication
(10) Pub. No.: US 2013/0008620 A1
(43) Pub. Date: Jan. 10, 2013

(54) Adjustable enclosure and method for enclosing a work space having a surface therein to be worked upon, the surface bearing a lead-based paint

(76) Inventor: Michael Cusick, Hadley, PA (US)

(21) Appl. No.: 13/178,120

(22) Filed: Jul. 7, 2011

(51) Int. Cl. A47G 5/00; B23P 11/00

(52) U.S. Cl. 160/372; 29/428

(57) ABSTRACT

Adjustable enclosure and method for enclosing a work space having a surface therein to be worked upon, the surface bearing a lead based paint. According to an exemplary embodiment, the adjustable enclosure comprises a plurality of height-adjustable uprights capable of accommodating ceilings of various heights and also capable of being disposed in spaced-apart relationship about various sizes of the work space. Each height-adjustable upright includes a clasp for reliably securing a portion of a plastic containment sheet adapted to contain lead-based paint dust and chips within the work space. Extent-adjustable horizontal connectors are capable of arranging the adjustable enclosure in a desired configuration about the work space. The adjustable enclosure is quickly and easily adaptable to building structures and work spaces of various sizes in order to contain lead-based paint dust and chips generated during renovation, repair and painting operations.

### FIELD OF THE INVENTION

This invention generally relates to enclosures and more particularly relates to an enclosure for enclosing a work space.

### BACKGROUND OF THE INVENTION

In 1996, the United States Environmental Protection Agency (EPA) passed a regulation aimed at preventing lead poisoning, particularly in children. This regulation became effective on Apr. 22, 2010 and is codified at Title 40 Code of Federal Regulations Part 745 (40 CFR 745, “Lead-Based Paint Poisoning Prevention In Certain Residential Structures”). Among other requirements, the regulation requires contractors performing renovation, repair and painting operations that might disturb lead-based paint in homes, child care facilities and schools built before 1978 to mitigate or prevent hazards associated with lead contamination.

This regulation was a response to concerns that lead released as dust or flakes during or after renovation, repair and painting operations would have serious toxic effects, particularly with respect to children. In this regard, presence of lead in the environment has been associated with reduced intelligence quotient (IQ), learning disabilities, neurocognitive or nervous system abnormalities and behavioral problems. This lead toxin can be ingested, such as by breathing of lead-bearing dust particles. Under the regulation, dust particles are defined as containing a mass-per-area concentration of lead equal to or exceeding 40 μg/ft² on floors or 250 μg/ft² on interior window sills. Such lead-bearing dust particles can be created by paint removal by means of abrasive sanding, window replacement, HVAC duct work, demolition of interior plaster walls, drilling into wood or plaster and/or sawing into wood or plaster. In addition, the lead toxin can be transferred to humans by contact with lead-bearing paint chips or flakes. Moreover, possibility of ingesting or contacting the lead toxin present in lead-based paint is significant. For example, it has been estimated that lead-based paint was used in millions of homes prior to the effective date of the EPA regulation. In 1978, for example, 13.5 million children in the United States had elevated lead blood levels (i.e., 10 μ/dl). In 2002, there were 310 thousand children with elevated lead blood levels.

Construction contractors and owners of schools, daycare centers and residential properties must comply with the EPA regulation when performing renovation, repair and painting operations, or when otherwise disturbing building structures. Compliance with the EPA regulation typically requires sealing an interior portion of a building and using a floor covering, among other protective measures. For example, replacing a window in a pre-1978 building with an energy efficient window of current design may generate lead-bearing paint dust and chips. Such lead-bearing paint dust and chips may be generated from the surface of the window itself or from the surface of a wall or ceiling near the window being replaced. In this example, the area surrounding the window being replaced should be enclosed to prevent dispersal of paint dust and chips into the environment. The lead-bearing paint dust and chips are subsequently collected and removed to a landfill designated for disposal of toxic materials.

Attempts to contain lead-bearing dust and chips during renovation, repair and painting operations are known. In one typical prior art approach, plastic sheeting is merely taped to the ceiling, walls and floor to enclose an area in which the renovation, repair and painting operations are to be performed, such as the area surrounding a window to be replaced. In this prior art approach, significant time is spent cutting the tape to size and adhering the tape to the ceiling, walls, floor and plastic sheeting. Therefore, this typical prior art approach does not appear to be quickly and easily deployable.

In another prior art approach, a containment box for use during window frame removal or other building structure modification is used to prevent toxic material from entering the environment, and particularly the inhabited areas of a building. However, the containment box of this prior art approach does not appear to be readily and easily adaptable to window frames or other building structures of various sizes. That is, it appears that the containment box is custom built to fit a window frame or other building structure of a specific size and is not necessarily reusable for a window frame or other building structure of a different size.

In yet another prior art approach, a pollution containment apparatus is provided for removal of polluted material from a ceiling and/or a wall and has a platform which can support a work person and which can be raised and lowered. A support on the platform holds an enclosure that has gloves and an attached waste bag. A portion of the top of the enclosure can be opened and closed for access to the polluted portion of the ceiling and/or wall. The entire, completely assembled, apparatus can be moved from one location to another. However, the enclosure of this prior art approach does not appear to be readily and easily adaptable to ceiling and/or wall portions of various sizes. That is, it appears that the enclosure is custom built to fit a ceiling and/or wall portion of a predetermined size and is not necessarily reusable for a ceiling and/or wall portion of a different size.

Hence, prior art approaches include taping plastic sheeting to ceilings, walls and floors to enclose an area; providing a containment box of a specific size to prevent toxic material from entering the environment; and providing a containment apparatus that has a platform which can be raised and lowered, the platform supporting an enclosure of a predetermined size that provides access to the polluted portion of the ceiling and/or wall. However, none of the prior art approaches mentioned hereinabove appears to provide the enclosure described and claimed hereinabelow.

### SUMMARY OF THE INVENTION

The present invention solves the shortcomings of the prior art approaches mentioned hereinabove by providing an adjustable enclosure for enclosing a work space having a surface therein to be worked upon. The surface may bear a lead-based paint or other toxic substance which is released from the surface in the form of dust particles and chips as the surface is worked upon. The surface to be worked upon may be a window sill, wall, floor, ceiling or other building structure.

According to the invention, an adjustable enclosure is provided that is quickly and easily adaptable to building structures of various sizes in order to contain lead-based paint dust and chips generated during renovation, repair and painting operations.

In one embodiment, a plurality of height-adjustable uprights are arranged near the work surface and may extend from the floor to the ceiling of a room containing the work surface. Interconnecting adjacent pairs of the height-adjustable uprights is a hinged, extent-adjustable horizontal connector capable of quickly adjusting the distance between each pair of height-adjustable uprights. The extent-adjustable horizontal connector is coupled to an upper end portion of the pair of height-adjustable uprights and is capable of being locked at the upper end portion. The combination of height-adjustable uprights and extent-adjustable horizontal connectors form a framework for the adjustable enclosure. A first clasp, such as an “alligator clip”, is coupled to the upper end portion of each height-adjustable upright and a second clasp is coupled to a lower end portion of each height-adjustable upright for vertically securing plastic sheeting to the height-adjustable uprights. As defined herein, an “alligator clip” is a clamp having serrated jaws that are hinged together. The second clasp also horizontally secures a separate plastic sheeting floor covering to the height-adjustable uprights. The vertically and horizontally secured plastic sheeting provide a barrier enclosing the work space for mitigating transport of lead paint dust particles and chips into the surrounding environment.

In another embodiment, the height-adjustable upright is spring biased, so that the height-adjustable upright can be more quickly and easily deployed between the floor and ceiling.

In yet another embodiment, the extent-adjustable horizontal connector is coupled to a lower end portion of the pair of height-adjustable uprights and is capable of being locked at the lower end portion.

In a further embodiment, a third clasp is coupled to the extent-adjustable connector in addition to the first and second clasps that are coupled to each height-adjustable upright.

In an additional embodiment, adjustable hinged connectors that are disposed vertically are connected to adjustable telescoping members that are disposed horizontally to form the framework for the adjustable enclosure.

According to an aspect of the invention, there is provided an adjustable enclosure for enclosing a work space having a surface therein to be worked upon, the surface bearing a lead-based paint, the adjustable enclosure comprising a plurality of height-adjustable uprights capable of being disposed in spaced-apart relationship about the work space, each height-adjustable upright having a top end and a bottom end, each height-adjustable upright having a clasp for reliably securing a portion of a plastic containment sheet adapted to contain lead-based paint debris within the work space; and a plurality of extent-adjustable horizontal connectors, each extent-adjustable horizontal connector being capable of connecting a pair of height-adjustable uprights selected from the plurality of height-adjustable uprights.

According to another aspect of the invention, there is provided an adjustable enclosure kit for enclosing a work space having a surface therein to be worked upon, the surface bearing a lead-based paint, the adjustable enclosure kit comprising a plurality of height-adjustable uprights capable of being disposed in spaced-apart relationship about the work space, each height-adjustable upright having a top end and a bottom end, each height-adjustable upright having a clasp for reliably securing a portion of a plastic containment sheet adapted to contain lead-based paint debris within the work space; and a plurality of extent-adjustable horizontal connectors, each extent-adjustable horizontal connector being capable of connecting a pair of height-adjustable uprights selected from the plurality of height-adjustable uprights.

According to yet another aspect of the invention, there is provided a method of assembling an adjustable enclosure for enclosing a work space having a surface therein to be worked upon, the surface bearing a lead-based paint, the method comprising providing a plurality of height-adjustable uprights capable of being disposed in spaced-apart relationship about the work space, each height-adjustable upright having a top end and a bottom end, each height-adjustable upright having a clasp for reliably securing a portion of a plastic containment sheet adapted to contain lead-based paint debris within the work space; providing a plurality of extent-adjustable horizontal connectors, each extent-adjustable horizontal connector being capable of connecting a pair of height-adjustable uprights selected from the plurality of height-adjustable uprights; and connecting a pair of height-adjustable uprights selected from the plurality of height-adjustable uprights using the extent-adjustable horizontal connector.

A feature of the present invention is the provision of an enclosure comprising a height-adjustable upright.

Another feature of the present invention is the provision of an enclosure comprising an extent-adjustable connector interconnecting a pair of the height-adjustable uprights.

A further feature of the present invention is the provision of a plurality of clasps coupled to respective ones of the height-adjustable uprights for securing plastic sheeting thereto.

In addition to the foregoing, various other method and/or device aspects and features are set forth and described in the teachings such as text (e.g., claims and/or detailed description) and/or drawings of the present invention.

The foregoing is a summary and thus may contain simplifications, generalizations, inclusions, and/or omissions of detail. Consequently, those skilled in the art will appreciate that the summary is illustrative only and is not intended to be in any way limiting. In addition to the illustrative aspects, embodiments, and features described hereinabove, further aspects, embodiments, and features will become apparent by reference to the drawings and the following detailed description.

### BRIEF DESCRIPTION OF THE DRAWINGS

The invention will be more fully understood by reference to the detailed description in conjunction with the following figures, wherein:

FIG. 1 is a view in perspective of a first embodiment adjustable enclosure for enclosing a work space having a surface therein to be worked upon, this first embodiment being configured in the form of a hollow rectangular or square prism and including a plurality of height-adjustable uprights;

FIG. 2 is a fragmentary view in vertical section of a first embodiment height-adjustable upright, this first embodiment height-adjustable upright defining a chamber therein containing a bullet-shaped engagement member;

FIG. 3 is a fragmentary view in vertical section of the first embodiment height-adjustable upright, this view showing the engagement member in a locked position and in an unlocked position presented in phantom;

FIG. 4 is a fragmentary view in vertical section of a second embodiment height-adjustable upright;

FIG. 5 is a fragmentary view in vertical section of a third embodiment height-adjustable upright;

FIG. 6 is a fragmentary view in elevation of a pair of first embodiment height-adjustable uprights interconnected by a first embodiment extent-adjustable connector that is illustrated in an expanded position, this view also showing a clasp connected to an end portion of each first embodiment height-adjustable upright;

FIG. 7 is a fragmentary view in elevation of the pair of first embodiment height-adjustable uprights interconnected by the first embodiment extent-adjustable connector that is illustrated in a collapsed position, this view also showing the clasp connected to the end portion of each first embodiment height-adjustable upright;

FIG. 8 is a view in perspective of a second embodiment adjustable enclosure for enclosing a work space having a surface therein to be worked upon, this second embodiment having at least one clasp connected to each extent-adjustable connector in addition to the clasps connected to the height-adjustable uprights;

FIG. 9 is a view in perspective of a third embodiment adjustable enclosure for enclosing a work space having a surface therein to be worked upon, this third embodiment including vertically arranged hinged connectors and horizontally arranged telescoping members;

FIG. 10 is a view in perspective of a fourth embodiment adjustable enclosure for enclosing a work space having a surface therein to be worked upon, this fourth embodiment having the extent-adjustable connector interconnecting a lower end portion of a pair of height-adjustable uprights;

FIG. 11 is a view in perspective of a fifth embodiment adjustable enclosure for enclosing a work space having a surface therein to be worked upon, this fifth embodiment being configured in the form of a hollow triangular prism; and

FIG. 12 is a flowchart of an illustrative method of assembling an adjustable enclosure for enclosing a work space having a surface therein to be worked upon, the surface bearing a lead-based paint.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the subject matter presented herein.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

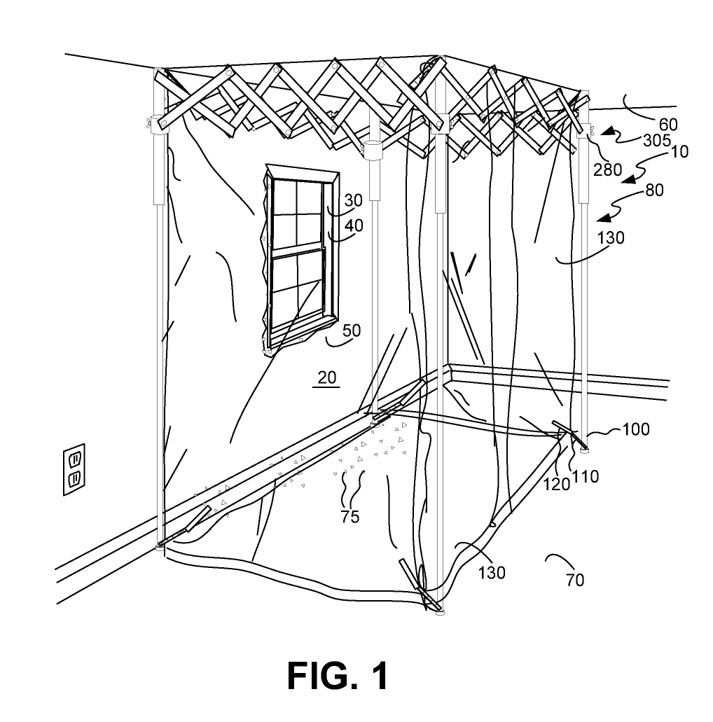

Therefore, with reference to FIG. 1, there is shown a first embodiment adjustable enclosure, generally referred to as 10, for enclosing a work space 20 having a surface 30 therein to be worked upon. By way of example only, and not by way of limitation, surface 30 may reside on a window sill 40, wall 50, ceiling 60, floor 70 or other building structure. Surface 30 is capable of producing dust and debris 75 while window sill 40, wall 50, ceiling 60, floor 70 or other building structure is being renovated, repaired, painted or otherwise worked upon. Also, by way of example only and not by way of limitation, first embodiment adjustable enclosure 10 may be configured as a hollow rectangular prism, as shown. However, although first embodiment adjustable enclosure 10 is shown configured as a hollow rectangular prism, other configurations are possible, as described more fully hereinbelow. Disposed on surface 30 and/or embedded in surface 30 is a toxic substance, such as lead bearing paint. However, surface 30 may contain other toxic substances in addition to or instead of lead bearing paint, the lead bearing paint being but one example. For example, surface 30 may contain asbestos. Also, it will be appreciated by a person skilled in the art that the adjustable enclosure may be present as a kit capable of being assembled into the configuration of first embodiment adjustable enclosure 10.

Referring again to FIG. 1, first embodiment adjustable enclosure 10 comprises a plurality of elongate first embodiment height-adjustable uprights, generally referred to as 80, that are capable of being disposed in spaced-apart relationship about a perimeter defined by work space 20. Thus, according to this first embodiment adjustable enclosure 10, first embodiment height-adjustable uprights 80 are arranged to define the geometric boundary of work space 20 (e.g., the geometric boundary of the previously mentioned hollow rectangular prism). Each first embodiment height-adjustable upright 80 is capable of being oriented vertically so as to extend from floor 70 to ceiling 60. More specifically, each first embodiment height-adjustable upright 80 has a top end 90 and a bottom end 100. Integrally connected to each of top end 90 and bottom end 100 is a flexible ligament 110, such as a flexible rope, cord, cable, tie, ribbon or the like. Ligament 110 may be made of any suitable material, such as fabric, rubber, or plastic. An end portion of each ligament 110 is attached to its respective top end 90 and bottom end 100 by any convenient means, such as by a bolt (not shown) or adhesive (also not shown). Attached to the other end portion of each ligament 110 is a clasp 120, such as an “alligator clip”, for reasons provided hereinbelow. As contemplated herein, the terminology “alligator clip” is defined as a clamp having serrated jaws that are hinged together.

Still referring to FIG. 1, each clasp 120 is capable of reliably gripping or securing a portion of a containment sheet 130, so that clasps 120 support containment sheet 130 around work space 20 in a curtain-like fashion. Containment sheet 130 is adapted to contain lead-based paint dust and debris 75, or other toxic substance, within work space 20. A plurality of containment sheets 130 will drape or hang vertically from clasps 120 while at least one containment sheet 130 simultaneously covers a portion of floor 70 that is located within work space 20. Containment sheet 130 and clasps 120 are manually manipulatable, so that clasps 120 are caused to secure containment sheet 130 thereto. Containment sheet 130, which may be transparent rather than opaque for unobstructed viewing of the interior of first embodiment enclosure 10, may be made of a commonly available flexible plastic material, such as polyethylene, polyvinyl chloride or the like having a suitable gauge or thickness for reducing weight of containment sheet 130, so that containment sheet 130 can be easily handled or manipulated.

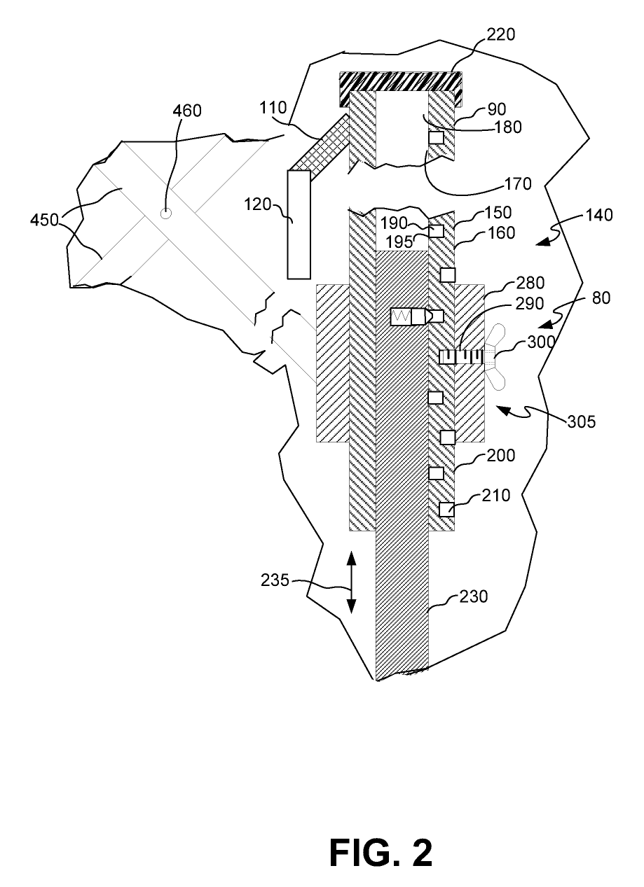

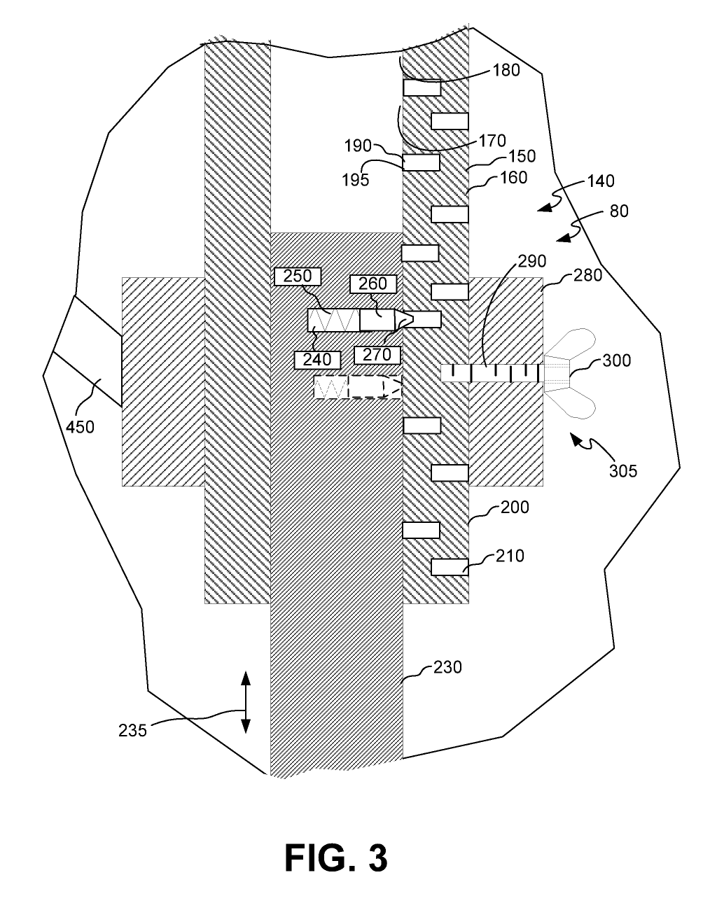

Turning now to FIGS. 2 and 3, first embodiment height-adjustable upright 80 comprises a length-lockable telescoping portion, generally referred to as 140. In this regard, length-lockable telescoping portion 140 includes an elongate first segment 150 having an annular wall 160. Wall 160 defines a bore 170 centrally formed in first segment 150 for reasons disclosed presently. Formed longitudinally along an inner surface 180 of annular wall 160 are a plurality of inner notches 190 for reasons disclosed momentarily. Each inner notch 190 includes an open mouth 195 for reasons disclosed hereinbelow. Also, formed longitudinally along an outer surface 200 of annular wall 160 are a plurality of outer notches 210 for reasons disclosed hereinbelow. Coupled to top end 90 of height-adjustable upright 80 and, therefore, coupled to a top end of elongate first segment 150 is a cushion 210, which may be rubber or the like, for preventing damage to ceiling 60 as the top end of first segment 150 abuts ceiling 60 in the manner disclosed hereinbelow. Length-lockable telescoping portion 140 further includes an elongate second segment 230 sized to slidably engage bore 170 in the direction of double-headed arrow 235. In addition, formed in second segment 230 is a chamber 240 having a resilient member 250, such as a spring, disposed in chamber 240. Resilient member 250 has a first portion thereof affixed within chamber 240 and a second portion thereof affixed to a bullet-shaped engagement member 260. Engagement member 260 has an integrally attached, generally conical nose portion 270 sized to engage open mouth 195 of inner notch 190. When second segment 230 is slidably moved in bore 170 in direction of double headed arrow 235, resilient member 250 will bias nose portion 270 into intimate sliding engagement with inner surface 180 of annular wall 160, such that second segment 230 may freely slide within bore 170. Second segment 230 can be pushed so as to slide within bore 170 a predetermined distance until engagement member 260 aligns with a preselected one of inner notches 190. The predetermined distance by which second segment 230 is caused to slide within bore 170 can depend on the distance between floor 70 and ceiling 60, so that first embodiment height-adjustable upright 80 extends from floor 70 to ceiling 60. As engagement member 260 aligns with the preselected one of inner notches 190, resilient member 260 will laterally bias engagement member 260 such that conical nose portion 270 engages open mouth 196 of inner notch 190. In this manner, second segment 230 will be fixed in position relative to first segment 150 until sufficient force, such as by means of manual manipulation, causes second segment 230 to again move in direction of double headed arrow 235. When second segment 230 is again moved in direction of double headed arrow 235, conical nose portion 270 will disengage inner notch 190 in order to slidably relocate second segment 230 within bore 170. Relocating second segment within bore 170 allows first embodiment height-adjustable upright 80 to be adjusted to reach ceilings 60 of various heights.

Referring again to FIGS. 2 and 3, telescoping portion 140 includes an annular sleeve 280 that surrounds a portion of outer surface 200 of first segment 150. Sleeve 280, which is movable along the longitudinal extent of elongate first segment 150, may define an internally threaded bore 290 perpendicularly therethrough for threadably receiving an externally threaded fastener 300, which may be a threaded wing nut. Sleeve 280 is capable of being releasibly fixed at a predetermined location on first segment 150 when an end portion of fastener 300 is aligned with and engages a preselected one of outer notches 210 and when fastener 300 is threadably tightened in threaded bore 290. Thus, sleeve 280, fastener 300, outer notch 210 and bore 290 provide a locking mechanism, generally referred to as 305, for locking telescoping portion 140 in position.

It may be appreciated that alternative configurations (not shown) for fastener 300 are possible. For example, fastener 300 and bore 290 need not be threaded. In this alternative, fastener 300 may lack external threads and bore 290 may lack internal threads. In this instance, fastener 300 may be spring biased by a suitable spring connected thereto. More specifically, manual manipulation of fastener 300 can cause fastener 300 to slide in bore 290 in a first direction so as to cause the end portion of fastener 300 to disengage outer notch 320. In this alternative case, the spring can then cause fastener 300 to horizontally slide within bore 290 in a second direction opposite the first direction when fastener 300 is released. When fastener 300 is released, the end portion of fastener 300 will engage outer notch 320. In other words, according to this alternative, fastener 300 is pulled to disengage outer notch 320 and then released to reengage outer notch 320 my means of the biasing action provided by the spring.

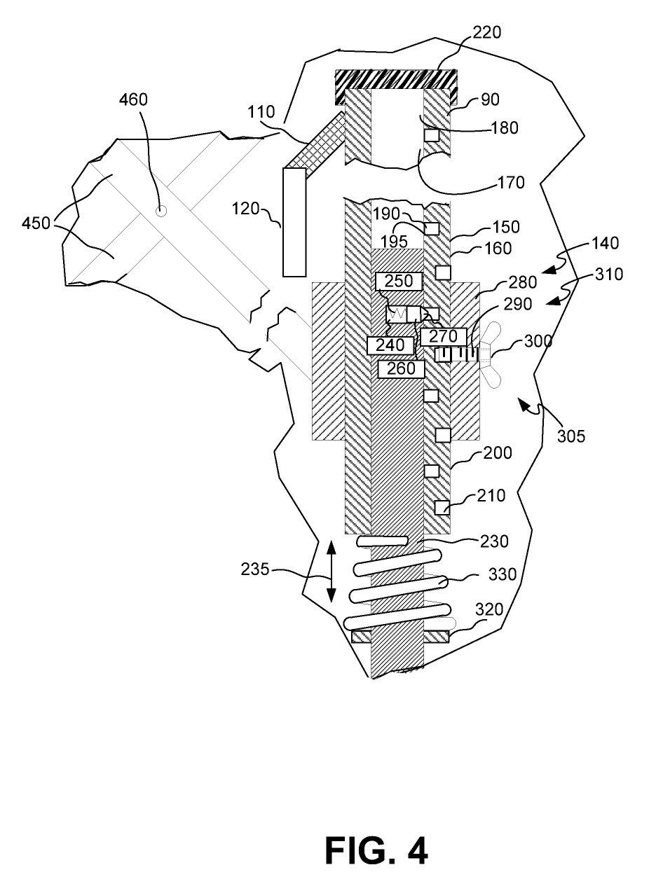

As best seen in FIG. 4, there is shown a second embodiment height-adjustable upright, generally referred to as 310. Second embodiment height-adjustable upright 310 is similar to first embodiment height-adjustable upright 80, except that an annular flange 320 radially surrounds second segment 230 and is integrally connected thereto. Also, flange 320 is spaced apart from an end of first segment 150. Interposed between flange 320 and the end of first segment 150, so as to rest on flange 320 and abut the end of first segment 150, is a biasing member 330, such as a coiled spring. Biasing member 330 is capable of upwardly biasing length-lockable portion 140. Thus, biasing member 330 may upwardly bias first segment 150, which includes length-lockable portion 140, until previously mentioned cushion 220 intimately engages ceiling 60. In this manner, second embodiment height-adjustable upright 310 can be quickly positioned and easily adjusted between ceiling 60 and floor 70.

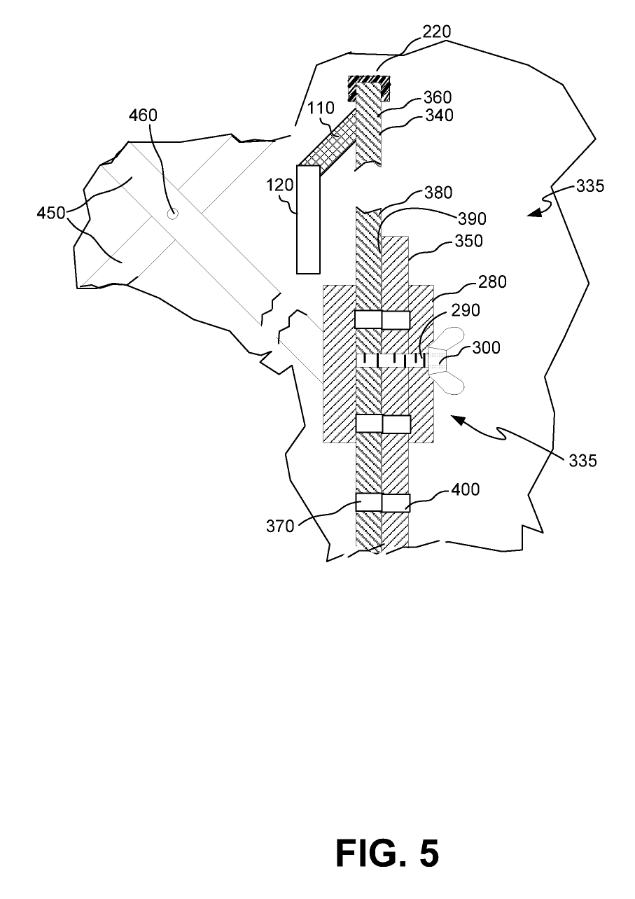

Referring to FIG. 5, a third embodiment height-adjustable upright, generally referred to as 335, comprises an elongate first rod 340 longitudinally abutting an elongate second rod 350. First rod 340 has a top end 360 to which is coupled previously mentioned cushion 220. Formed horizontally through first rod 340 are a plurality of first through-holes 370 spaced along elongate first rod 340. First rod 340 also defines a first exterior surface 380 that slidably engages a second exterior surface 390 belonging to second rod 350. Formed horizontally through second rod 350 are a plurality of second through-holes 400 spaced along elongate second rod 350. Previously mentioned sleeve 280 surrounds first rod 340 and second rod 350. Also, previously mentioned internally threaded bore 290 that receives externally threaded fastener 300 is aligned with a selected one of second holes 400 which in turn is aligned with a selected one of first holes 370. At this point, fastener 300 is caused, such as by manual manipulation, to engage bore 290, second hole 400 and first hole 370 in order to releasibly lock sleeve 280, first rod 340 and second rod 350 together. In this manner, first rod 340 is releasibly locked in a predetermined vertical position. Thus, in order to manually extend and retract first rod 340, fastener 300 is caused to engage and disengage bore 390, first holes 370 and second holes 400.

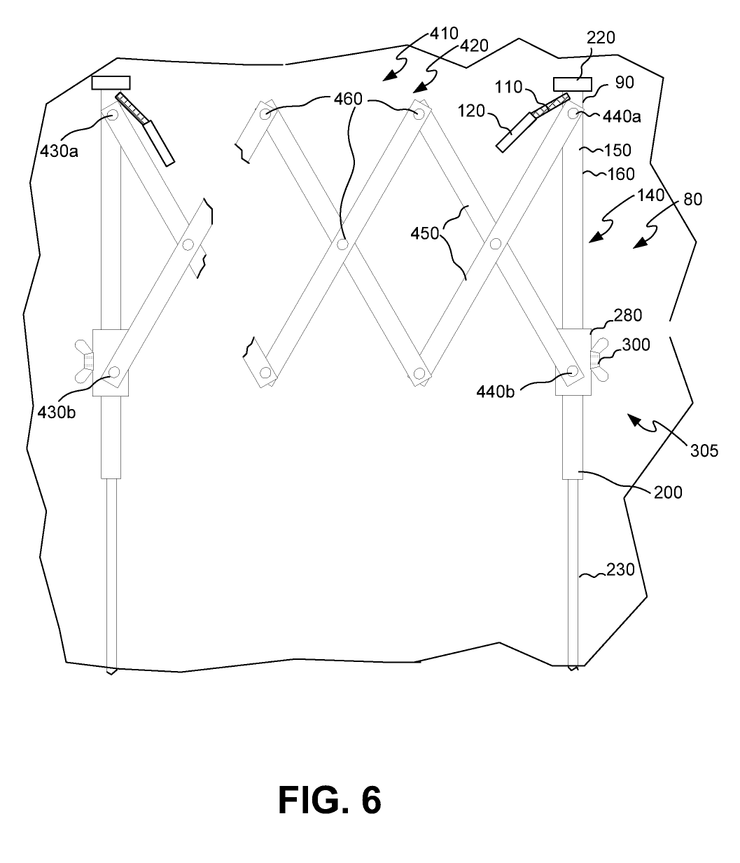

Referring to FIGS. 1, 2, 3, 4, 5 and 6, a plurality of first embodiment extent-adjustable horizontal connectors, generally referred to as 410, are provided for adjustably configuring first embodiment enclosure 10, so as to accommodate work spaces 20 of various sizes. In this regard, each first embodiment extent-adjustable horizontal connector 410 is capable of connecting a pair of adjacent first embodiment height-adjustable uprights 80 selected from the plurality of first embodiment height-adjustable uprights 80. Although the description hereinafter discusses first embodiment extent-adjustable horizontal connector 410 in relation to first embodiment height-adjustable uprights 80, it should be understood that first embodiment extent-adjustable horizontal connector 410 is usable with second and third embodiment height-adjustable uprights 310/335, as well.

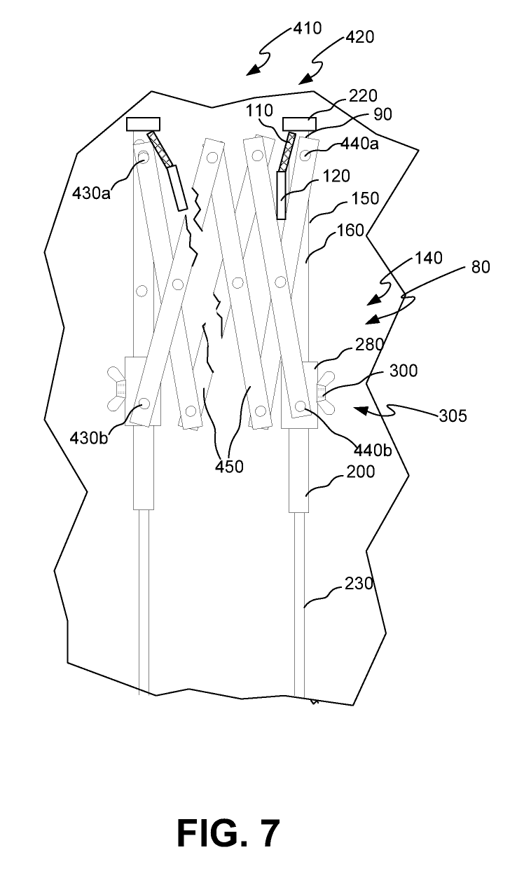

Referring to FIGS. 1, 2, 3, 4, 5, 6 and 7, at least one extent-adjustable horizontal connector 410 may comprise a criss-cross strut arrangement, generally referred to as 420. A first end portion of strut arrangement 420 is pivotably coupled to a first one of the pair of first embodiment height-adjustable uprights 80, such as by first pivot pins 430a and 430b. In addition, a second end portion of strut arrangement 420 is pivotably coupled to a second one of the pair of first embodiment height-adjustable uprights 80, such as by second pivot pins 440a and 440b. In this manner, strut arrangement 420 is configured in an accordion-like fashion to quickly and easily adjust distance between the pair of first embodiment height-adjustable uprights 80. More specifically, strut arrangement 420 comprises a plurality of interconnected struts 450 hinged one to another, such as by lynch pins 460. In this manner, lynch pins 460 in combination with struts 450 allow hinged extension and contraction of extent-adjustable horizontal connector 410, as shown. In addition, at least one strut 450 at each end of strut arrangement 420 is coupled to previously mentioned locking mechanism 305, so that strut arrangement 420 is locked to the pair of first embodiment height-adjustable uprights 80.

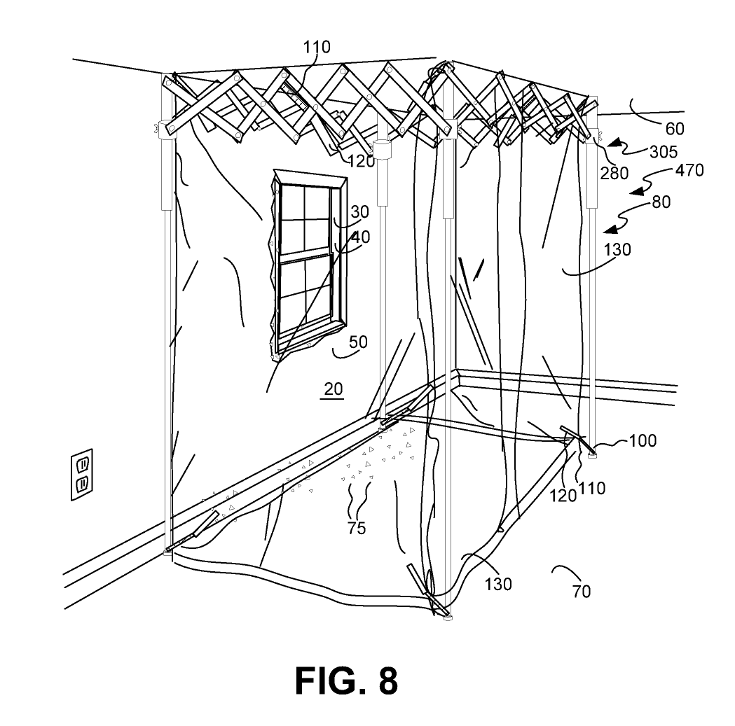

Referring to FIG. 8, a second embodiment adjustable enclosure, generally referred to as 470, is there shown. Second embodiment adjustable enclosure 470 is similar to first embodiment adjustable enclosure 10. However, according to this second embodiment adjustable enclosure 470, at least one clasp 120 is coupled to each extent-adjustable horizontal connector 410, in addition to clasps 120 that are coupled to height-adjustable uprights 80. In this manner, portions of containment sheet 130 can hang from extent-adjustable horizontal connectors 410 as well as first embodiment height-adjustable uprights 80. Presence of clasp 120 that is coupled to each extent-adjustable horizontal connector 410 provides increased assurance that containment sheet 130 reliably surrounds work space 20.

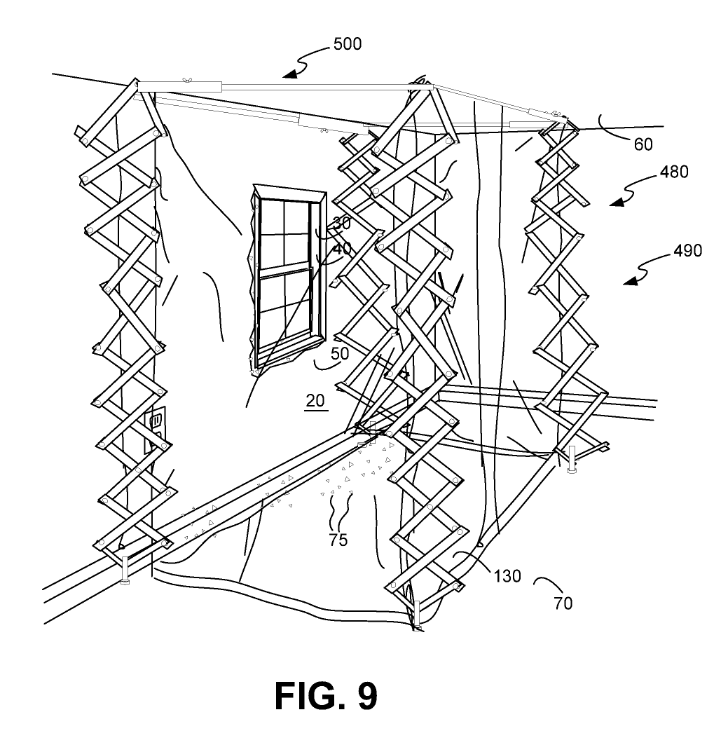

Referring to FIG. 9, a third embodiment adjustable enclosure, generally referred to as 480, is there shown. Third embodiment adjustable enclosure 480 is similar to first embodiment adjustable enclosure 10. However, according to this third embodiment adjustable enclosure 480, a plurality of height-adjustable hinged connectors, generally referred to as 490, replaces first embodiment height-adjustable uprights 80. In addition, a plurality of elongate extent-adjustable horizontal telescoping members generally referred to as 500, replaces extent-adjustable horizontal connectors 410. This third embodiment adjustable enclosure 480 provides an alternative means of enclosing work space 20.

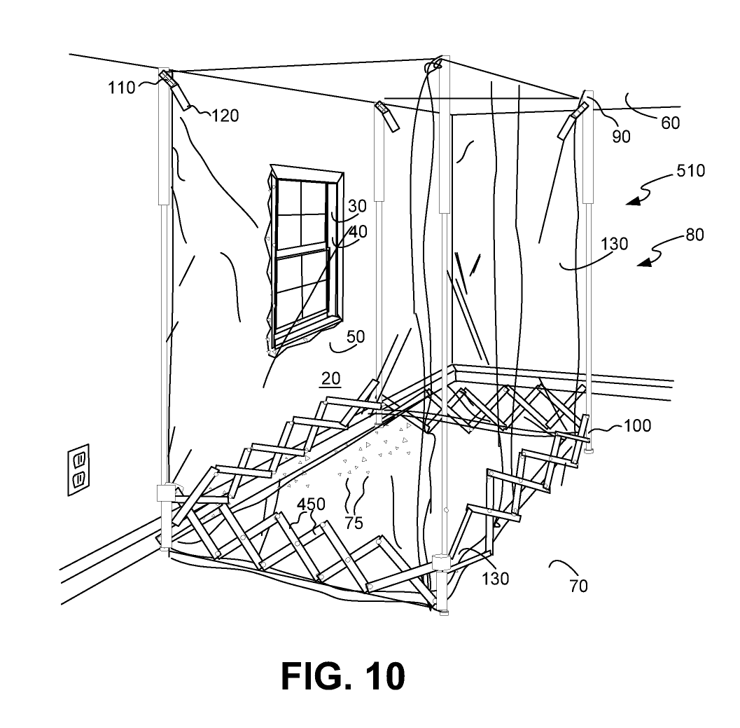

Referring to FIG. 10, a fourth embodiment adjustable enclosure, generally referred to as 510, is there shown. Fourth embodiment adjustable enclosure 510 is similar to first embodiment adjustable enclosure 10. However, according to this fourth embodiment adjustable enclosure 510, extent-adjustable horizontal connectors 410 are disposed at bottom end 100 of respective ones of first embodiment height-adjustable uprights 80. This fourth embodiment adjustable enclosure 510 is useful when it is necessary to have extent-adjustable horizontal connector 410 avoid interference with building structures or fixtures disposed on or hanging from ceiling 60.

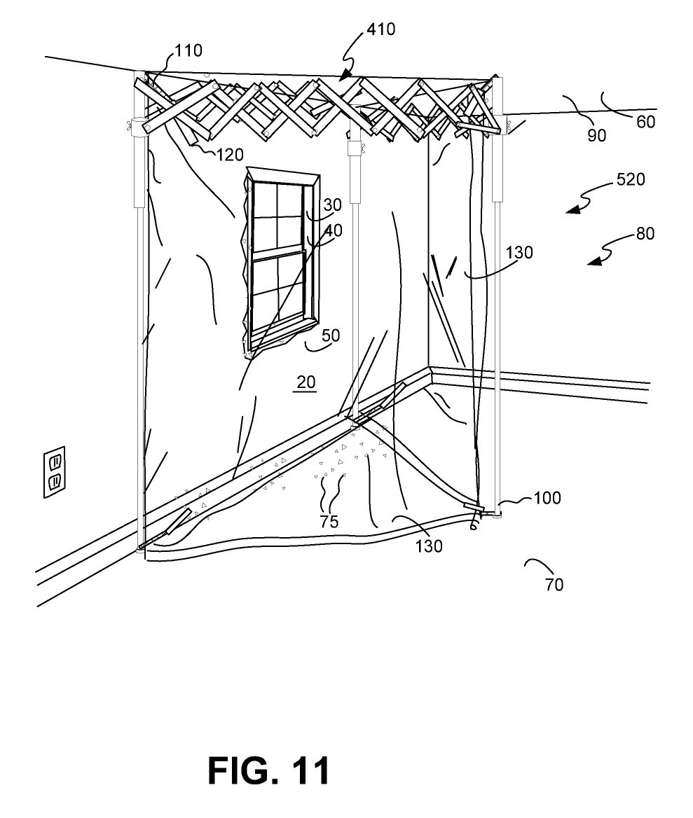

Referring to FIG. 11, a fifth embodiment adjustable enclosure, generally referred to as 520, is there shown that is similar to first embodiment adjustable enclosure 10. However, according to this fifth embodiment adjustable enclosure 520, a hollow triangular prism configuration is defined rather than the hollow rectangular or square prism configuration defined by first embodiment adjustable enclosure 10.

### Illustrative Methods

An illustrative method associated with exemplary embodiments for assembling an adjustable enclosure for enclosing a work space having a surface therein to be worked upon, the surface bearing a lead-based paint, will now be described.

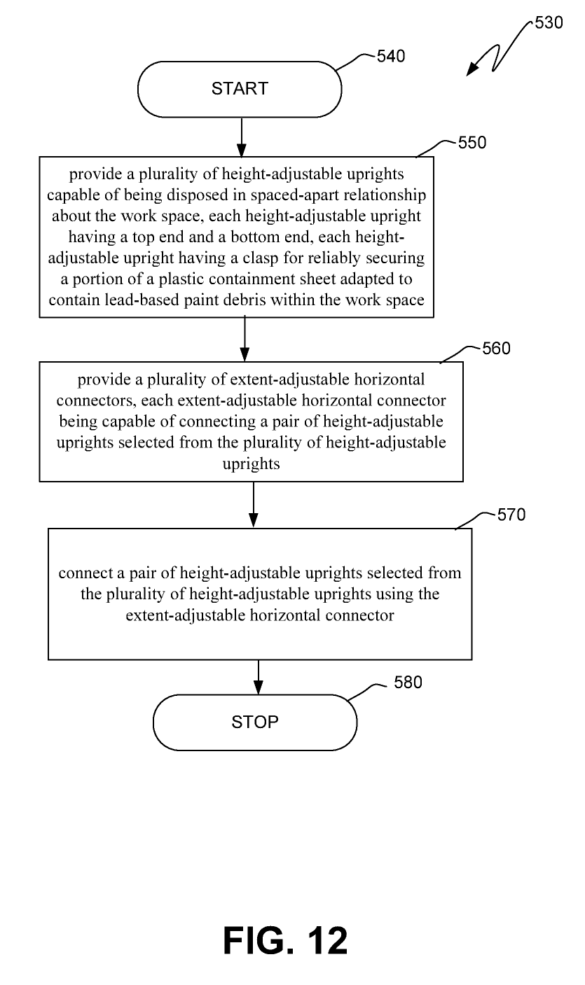

Referring to FIG. 12, an illustrative method 530 that is provided for enclosing a work space having a surface therein to be worked upon, the surface bearing a lead-based paint, starts at a block 540. At a block 550, the method comprises providing a plurality of height-adjustable uprights capable of being disposed in spaced-apart relationship about the work space, each height-adjustable upright having a top end and a bottom end, each height-adjustable upright having a clasp for reliably securing a portion of a plastic containment sheet adapted to contain lead-based paint debris within the work space. At a block 560, a plurality of extent-adjustable horizontal connectors are provided, each extent-adjustable horizontal connector being capable of connecting a pair of height-adjustable uprights selected from the plurality of height-adjustable uprights. At a block 570, a pair of height-adjustable uprights selected from the plurality of height-adjustable uprights are connected using the extent-adjustable horizontal connector. The method stops at a block 580.

Therefore, what is provided is an enclosure that is quickly and easily adaptable to building structures of various sizes in order to contain lead-based paint dust and chips generated during renovation, repair and painting operations.

Other modifications and implementations will occur to those skilled in the art without departing from the spirit and the scope of the invention as claimed. For example, a vacuum suction device may be connected to the adjustable enclosure and disposed in vacuum communication with work space 20 for vacuuming lead-bearing dust and debris from work space 20. Accordingly, the description hereinabove is not intended to limit the invention, except as indicated in the following claims.

What is claimed is:

1. An adjustable enclosure for enclosing a work space having a surface therein to be worked upon, the surface bearing a lead-based paint, the adjustable enclosure comprising:
a plurality of height-adjustable uprights capable of being disposed in spaced-apart relationship about the work space, each height-adjustable upright having a top end and a bottom end, each height-adjustable upright having a clasp for reliably securing a portion of a plastic containment sheet adapted to contain lead-based paint debris within the work space; and
a plurality of extent-adjustable horizontal connectors, each extent-adjustable horizontal connector being capable of connecting a pair of height-adjustable uprights selected from the plurality of height-adjustable uprights.

2. The adjustable enclosure of claim 1, wherein at least one of the plurality of height-adjustable uprights has the clasp at the top end, the clasp being for securing the portion of the plastic containment sheet.

3. The adjustable enclosure of claim 1, wherein at least one of the plurality of height-adjustable uprights has the clasp at the bottom end, the clasp being for securing the portion of the plastic containment sheet.

4. The adjustable enclosure of claim 1, wherein at least one of the plurality of extent-adjustable horizontal connectors has at least one clasp for securing the portion of the plastic containment sheet.

5. The adjustable enclosure of claim 1, wherein at least one of the plurality of height-adjustable uprights comprises a length-lockable telescoping portion.

6. The adjustable enclosure of claim 5, further comprising a biasing member coupled to the length-lockable telescoping portion for biasing the length-lockable telescoping portion.

7. The adjustable enclosure of claim 1, wherein at least one of the plurality of extent-adjustable horizontal connectors comprises a criss-cross strut arrangement.

8. The adjustable enclosure of claim 7, wherein the criss-cross strut arrangement comprises a plurality of interconnected struts hinged one to another for allowing hinged extension of the at least one of the plurality of extent-adjustable horizontal connectors.

9. The adjustable enclosure of claim 1, wherein at least one of the plurality of extent-adjustable horizontal connectors comprises a length-lockable telescoping portion.

10. The adjustable enclosure of claim 9, further comprising a biasing member coupled to the length-lockable telescoping portion for biasing the length-lockable telescoping portion.

11. The adjustable enclosure of claim 1, wherein the clasp is capable of releasibly clasping the containment sheet.

12. The adjustable enclosure of claim 1, wherein a plurality of clasps supports the containment sheet around the work space in a curtain-like fashion.

13. The adjustable enclosure of claim 1, further comprising a locking mechanism coupled to each of the plurality of height-adjustable uprights for releasibly locking each of the plurality of height-adjustable uprights in a predetermined position.

14. The adjustable enclosure of claim 1, further comprising a locking mechanism coupled to each of the plurality of extent-adjustable horizontal connectors for releasibly locking each of the plurality of extent-adjustable horizontal connectors in a predetermined position.

15. An adjustable enclosure kit for enclosing a work space having a surface therein to be worked upon, the surface bearing a lead-based paint, the adjustable enclosure kit comprising:
a plurality of height-adjustable uprights capable of being disposed in spaced-apart relationship about the work space, each height-adjustable upright having a top end and a bottom end, each height-adjustable upright having a clasp for reliably securing a portion of a plastic containment sheet adapted to contain lead-based paint debris within the work space; and
a plurality of extent-adjustable horizontal connectors, each extent-adjustable horizontal connector being capable of connecting a pair of height-adjustable uprights selected from the plurality of height-adjustable uprights.

16. The adjustable enclosure kit of claim 15, wherein at least one of the plurality of height-adjustable uprights has the clasp at the top end, the clasp being for securing the portion of the plastic containment sheet.

17. The adjustable enclosure kit of claim 15, wherein at least one of the plurality of height-adjustable uprights has the clasp at the bottom end, the clasp being for securing the portion of the plastic containment sheet.

18. The adjustable enclosure kit of claim 15, wherein at least one of the plurality of extent-adjustable horizontal connectors has at least one clasp for securing the portion of the plastic containment sheet.

19. The adjustable enclosure kit of claim 15, wherein at least one of the plurality of height-adjustable uprights comprises a length-lockable telescoping portion.

20. The adjustable enclosure kit of claim 19, further comprising a biasing member coupled to the length-lockable telescoping portion for biasing the length-lockable telescoping portion.

21. The adjustable enclosure kit of claim 15, wherein at least one of the plurality of extent-adjustable horizontal connectors comprises a criss-cross strut arrangement.

22. The adjustable enclosure kit of claim 21, wherein the criss-cross strut arrangement comprises a plurality of interconnected struts hinged one to another for allowing hinged extension of the at least one of the plurality of extent-adjustable horizontal connectors.

23. The adjustable enclosure kit of claim 15, wherein at least one of the plurality of extent-adjustable horizontal connectors comprises a length-lockable telescoping portion.

24. The adjustable enclosure kit of claim 23, further comprising a biasing member coupled to the length-lockable telescoping portion for biasing the length-lockable telescoping portion.

25. The adjustable enclosure kit of claim 15, wherein the clasp is capable of releasibly clasping the containment sheet.

26. The adjustable enclosure kit of claim 15, wherein a plurality of clasps supports the containment sheet around the work space in a curtain-like fashion.

27. The adjustable enclosure kit of claim 15, further comprising a locking mechanism coupled to each of the plurality of height-adjustable uprights for releasibly locking each of the plurality of height-adjustable uprights in a predetermined position.

28. The adjustable enclosure kit of claim 15, further comprising a locking mechanism coupled to each of the plurality of extent-adjustable horizontal connectors for releasibly locking each of the plurality of extent-adjustable horizontal connectors in a predetermined position.

29. A method of assembling an adjustable enclosure for enclosing a work space having a surface therein to be worked upon, the surface bearing a lead-based paint, the method comprising:
providing a plurality of height-adjustable uprights capable of being disposed in spaced-apart relationship about the work space, each height-adjustable upright having a top end and a bottom end, each height-adjustable upright having a clasp for reliably securing a portion of a plastic containment sheet adapted to contain lead-based paint debris within the work space;
providing a plurality of extent-adjustable horizontal connectors, each extent-adjustable horizontal connector being capable of connecting a pair of height-adjustable uprights selected from the plurality of height-adjustable uprights; and
connecting a pair of height-adjustable uprights selected from the plurality of height-adjustable uprights using the extent-adjustable horizontal connector.
